(19) United States
(12) Patent Application Publication
(10) Pub. No.: US 2024/0217593 A1
(43) Pub. Date: Jul. 4, 2024

(54) Top application of an autonomous vehicle

(71) Applicant: Clevon AS, Viljandi (EE)

(72) Inventors: Remi Lõssov, Viljandi (EE); Arno Kütt, Peetrimõisa village (EE)

(21) Appl. No.: 18/397,588

(22) Filed: Dec. 27, 2023

Related U.S. Application Data
(60) Provisional application No. 63/477,675, filed on Dec. 29, 2022.

(51) Int. Cl. B62D 33/04; B60P 1/64

(52) U.S. Cl. CPC B62D 33/042; B60P 1/6418

(57) ABSTRACT

A top application for on an autonomous delivery vehicle is disclosed. The top application may be attached to the vehicle permanently or removably. The top application has at least one vertical compartment section having a housing for one or more compartments defined by shelves, and a computer operated sliding door assembly. The sliding door assembly comprises a bottom door module and a top door module configured to slidingly move along door guide rails such that the door assembly is closed when a lower edge of the top door assembly and the upper edge of the bottom door assembly are adjacent to each other. The door assembly is configured to move to a position where the adjacent edges locate at a level of a predetermined shelf. The top door module moves upward, or the bottom door module moves downward to create an access opening at the level of the predetermined shelf.

### PRIORITY

This application claims priority to U.S. Provisional application No. 63/477,675 filed on Dec. 29, 2022.

### FIELD OF THE INVENTION

This invention relates to autonomous vehicles that have at least one top application to store and deliver parcels. More specifically, the invention describes a dynamic top application developed for safe and secure delivery of parcels to customers and which allows the possibility for each customer to have access to a private compartment.

### BACKGROUND

A number of top application solutions are known from the existing technology. Some known solutions include autonomous delivery vehicles with multitude of storage compartments and means to eject a ramp for depositing the delivery items (U.S. Pat. No. 11,276,030). This solution is aimed for situations where the delivery items are deposited in a predetermined location into some type of customer container. Some other solutions provide direct access for the customer to retrieve an item directly from the autonomous delivery vehicle. Such solutions are disclosed for example in US20190073631, U.S. Pat. Nos. 11,210,726, 11,222,378. Some solutions provide specifically designed set of sliding doors to allow access to predetermined compartment of the autonomous vehicle's cargo box: in U.S. Pat. Nos. 10,592,851, 10,479,418 the cargo pod of an autonomous vehicle has two sets of sliding doors, where one slides in vertical direction and one in horizontal direction to provide access to individual compartment spaces in the pod.

The main disadvantage of the known solutions is that often times the top application (i.e. cargo box, cargo container, cargo pod) is very heavy and therefore difficult to manage. Heavy weight also leads to limitations to the autonomous vehicle itself. Weight limitations are of essence for example for speeds that the vehicle can drive, as well as for safety issues in the traffic.

Further problems may arise from the fact that usually the top application is equipped with only one door. This may cause a safety issue for example because the items to be retrieved have to be retrieved always from one side of the vehicle. Furthermore, if there are any technical problems with the one door, the customers may not be able to retrieve their packages. Also, for security purposes it is necessary that there is no access or view for a customer to compartments of other customers.

Moreover, none of the currently available solutions provide a dynamic top application, with options to modify the number and/or position of doors, as well as the position, size, number and location of the compartments.

Yet another issue may be that the top application does not allow for several compartments to be opened at same time or one after another without customer separately identifying himself/herself each time one compartment is emptied. Such situation could happen for example when the customer has ordered several items which do not fit into one compartment, but several compartments contain items for the one customer.

Furthermore, the top applications currently known are often times rigidly mounted on the autonomous vehicle, which makes it difficult to ensure smooth functioning of the assemblies of the top applications. A distortion of the autonomous vehicle may also transfer to the top application. Moreover, rigidly mounted top applications may have limited possibilities in combination with the vehicle, as a result of which the full potential of the vehicle may be left unused.

Accordingly, and especially because there is a constantly increasing need for autonomous vehicles for delivery of ordered items, there is a need for a top application for an autonomous vehicle which provides easy access, which is light and interchangeable, which has a safe and dynamic opening and storing system allowing changing the compartment volume as well as easy and fast access to items from several compartments and at same time avoiding exposure of contents of further compartments.

### SUMMARY OF THE INVENTION

It is an object of this invention to provide a dynamic top application configured to be mounted permanently or removably on an autonomous delivery vehicle, the top application comprising:
a base frame comprising means for attachment onto the autonomous delivery vehicle;
an arrangement of at least one vertical compartment section on the base frame;
the at least one vertical compartment section comprising a housing for one or more compartments defined by shelves, and a computer operated sliding door assembly,
wherein the sliding door assembly comprises a bottom door module and a top door module configured to slidingly move along door guide rails such that the door assembly is closed when a lower edge of the top door assembly and the upper edge of the bottom door assembly are adjacent to each other,
the door assembly being configured to move to a position where the adjacent edges locate at a level of a predetermined shelf, after which the top door module is moving upward or the bottom door module is moving downward to create an access opening between the door modules at the level of the predetermined shelf for inserting a parcel to or receiving a parcel from the predetermined shelf.

In certain aspects the opening of access to a predetermined shelf is triggered by entering an individualized code containing information related to the parcel.

According to certain aspects of the invention the top application has multiple vertical compartment sections, preferably three vertical compartment sections, but four or five vertical compartment sections is also possible. The sliding door assemblies of each vertical compartment section according to this invention are openable and closable independently of each other.

In certain aspects of the invention the top application has at least one single sided vertical compartment section having a sliding door assembly only on one side.

In certain aspects of the invention the top application has at least one double sided vertical compartment section having a sliding door assembly on two sides of the section.

In certain aspects of the invention, the top application has multiple vertical compartment sections comprising both single sided and double side sections.

It is an object of this invention to provide a top application having a multitude of vertical compartment sections, wherein each vertical compartment section is capable of providing access to a compartment simultaneously, thereby allowing insert or retrieval of several parcels in separate compartments simultaneously.

According to certain aspects of the invention the top application has a battery power.

It is an object of this invention to provide a dynamic top application, wherein size of the compartments may be changed based on actual size of items stored in top application by removing and rearranging shelves in one or more vertical compartment sections.

An object of the invention is to provide a dynamic top application mountable on top of the vehicle permanently or in a removable manner.

This disclosure provides a top application configured to be mounted on the autonomous vehicle. The top application includes the following modules:
a) A base frame is the surface onto which other modules are mounted. As a standard solution, the base frame has bolted connections and the anchorage points of the base frame are fixed by bolts to shock-absorbing anchorage points on the vehicle. The shock-absorbing anchorage points are preferably special rubber pads that soften the potential distortion of the autonomous vehicle under uneven road conditions. As an alternative solution, the top application can be mounted on the autonomous vehicle with a base frame that has three anchorage points. Two of the forward-facing anchorages operate on the principle that the mounting plates are installed in the openings and when pushed forward the plates will be in such a position that they cannot be lifted up. Secure attachment is ensured by manually operated spring pins. The third rear anchorage system consists of three parts: a spherical head attached to the base frame of the top application, mounting module on the vehicle for the spherical head, and a securing clip. When the two forward-facing anchorages are fixed into place, the top application is lowered down such that the spherical head is in its socket located in the mounting module. The three anchorage points prevent the autonomous vehicle from impacting the top application. The system with three anchorage points can be opened and closed manually. The system provides easy removal and mounting of the top application.
b) An arrangement of one or more vertical compartment sections is assembled on top of the base frame. Each vertical compartment section has two vertically sliding door modules (a top door module, and a bottom door module)—goods/parcels can be accessed from one side of the vehicle or both sides of the vehicle through an access opening provided by operation of the sliding door assembly. The dimensions of the vertical compartment section(s) are determined by the size of the base frame and the number of vertical compartment sections to be fitted onto the base frame. Individual compartments with desired sized can be arranged into each vertical compartment section based on size of items/parcels to be stored. The number of compartments in each vertical compartment section has not been fixed from the outset. Each vertical section contains shelving tracks installed on the inner walls of the vertical compartment sections. Shelves can be assembled onto the shelving tracks based on need. The system allows changing the spacing at any time to ensure sufficient spacing for both small and large parcels. Upon the insertion of the shelves, the computerized system can automatically detect by means of sensors installed at the ends of shelving tracks the distance between each two shelves on top of each other and based on this define how the door modules have to move in order to provide an access opening to a predetermined compartment.
   Each vertical compartment section is equipped with two sliding door modules: one door module is installed at the top (top door module) and another at the bottom (bottom door module) of the vertical compartment section. The doors are in a closed position when the bottom door module has moved from the bottom up to the mid-point of the vertical compartment section and the top door module has moved down to the mid-point of the vertical section. In the closed position, a lower edge of the top door module and a top edge of the lower door module touch each other (adjacent edges). If there are no shelves in the vertical compartment section, i.e. the vertical compartment section has just one continuous space, only parcel(s) of one customer can be placed inside the section and access to the entire compartment will be provided by the sliding doors while the bottom door module moves all the way down and the top door module moves all the way up. If any number of shelves is inserted into the vertical compartment section, new compartments are created from the one continuous space and in this case the door modules open as follows: the door modules move together in closed position until the top edge of the bottom door module reaches the shelf on which the parcel is placed, after this only the top door module keeps moving upward until the compartment is open, i.e. the bottom edge of the top door module is at a level just high enough to allow the parcel to be accessible through the access opening between the edges of the door modules and the customer can retrieve their parcel.
c) Light-weight cover panels are mounted on the base frame and vertical sections. The electrical and communications connections are housed under the cover panels, but they may also be installed elsewhere under the easily accessible cover panel.

In the invention according to this disclosure, the top application has full control of the compartments and the parcels therein even when the top application is removed from the vehicle and transferred onto another vehicle or left at a certain location to serve customers for a specified time period after the end of which the top application will be removed. When removed from the autonomous vehicle the top application may utilize internal battery power. As an alternative solution, the top application may also be stationary, i.e., part of the design of the autonomous vehicle, in which case, it is never removed from the vehicle.

The invention is now described with the appended drawings and following detailed description.

### BRIEF DESCRIPTION OF THE DRAWINGS

FIG. 1: Perspective view of the top application (2) on the autonomous vehicle (1).

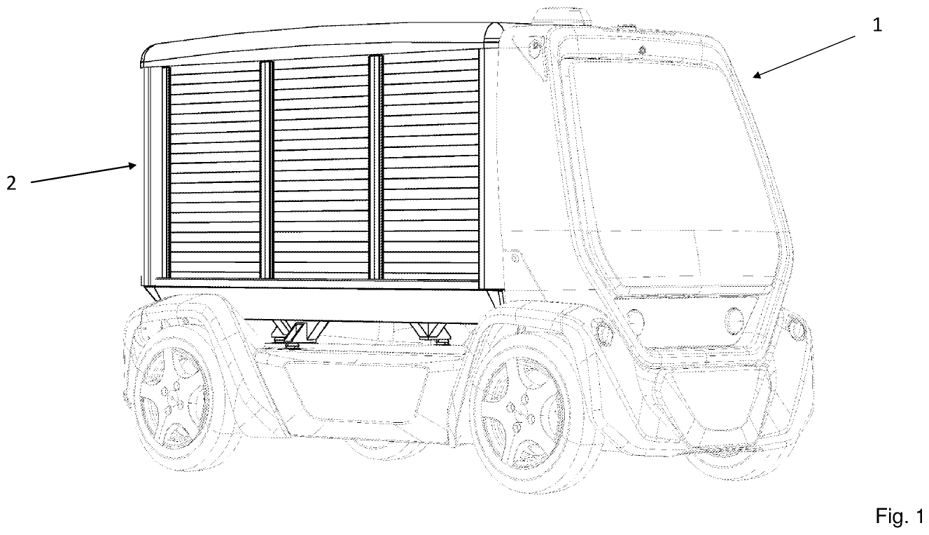

FIG. 2: Perspective view of the top application (2) detached from the autonomous vehicle. The top application has three vertical compartment sections (3) each covered by a sliding door assembly (shown in detail in FIGS. 8,12,13). Cover panels (4) of the top application are shown here. Anchorage points for bolted connections (6) are attached in bottom of the top application. (Further details are shown in FIG. 10).

FIG. 3: An exploded view of the top application (2), showing three vertical compartment sections (3); cover panels (4), electricity and communications connections (26), and a base frame (5). Elements (7) and (8) illustrate top door module and bottom door module, respectively. The door modules are in fully open position providing access openings for the entire space inside each vertical compartment sections.

FIG. 4: Perspective view of a single-sided vertical compartment section (3). Side wall of one side is removed to show the shelves (13) inside the compartment section. Element number (9) illustrates the horizontal door guide rails and element (11) illustrate vertical door guide rails. Elements (7) and (8) illustrate top door module and bottom door module, respectively. The door modules in this illustration are in closed position, i.e. the lower edge of the top door module and the upper edge of bottom door module are touching each other (i.e. the edges are adjacent edges 10). Horizontal strips (39) of the door modules are shown in the figure. Element number (37) illustrates weatherproof seals at the vertical door guide rails. Element (17) is a connecting guide rail between the horizontal and vertical door guide rails. Element (15) illustrates the housing of the vertical compartment section.

FIG. 5: Perspective view of a double-sided vertical compartment section (3). The vertical compartment section here has two sets of vertically arranged compartments separated by vertical partition (40). Each set of the compartments has a multitude of shelves (13) (side wall of one side is removed to show the shelves inside each compartment sets). Element (9) is the horizontal door guide rail that in this case stretches across both of the compartment sets. Elements (7) and (8) illustrate top door module and bottom door module, respectively. The door modules in this illustration are in closed position, i.e. the lower edge of the top door module and the upper edge of bottom door module are touching each other (i.e. the edges are adjacent edges 10).

FIG. 6: Perspective view of double-sided vertical compartment section (3) having two sets of vertical compartments with separate circular tracks (12). The separate circular tracks are formed of horizontal (9), and vertical (11) door guide rails connected with connecting rails in a same manner as is shown in FIG. 5. Side wall of one side of the vertical compartment section is removed to show the shelves (13) inside the two sets of compartments. Elements (7) and (8) illustrate top door module and bottom door module, respectively.

FIG. 7: Exploded view of the parts of a vertical compartment section (3). The shown structure is used in the construction of all types of vertical compartment sections. Element (9) illustrates the horizontal door guide rail. Element (11) is the vertical door guide rail. Element (17) is the connecting guide rail. Element (15) illustrates the housing of the vertical compartment section. Element (27) is the side wall of the housing, element (28) is the ceiling of the housing, element (29) is the back wall of the housing, and (30) is the floor of the housing. Element (31) illustrates the shelving tracks, element (32) illustrates internal lighting, and element (33) illustrates shelf height sensors. Element (14) is the drive module.

FIG. 8: Perspective view of the drive logic used to move the door modules of the vertical compartment sections. Each vertical compartment section has an independent door opening and closing mechanism. In this figure element (35) illustrates the vertical door guide rails (corresponds to element (11) in other drawings). Element (34) illustrates the horizontal door guide (corresponds to element (9) in other drawings). Element (17) is the connecting guide rail. The drawing shows the drive wheel (18), the toothed strip ends (19), bearing housing (36), a door home senor (38), stabiliser plate (41) and stabiliser plate response (42).

FIG. 9: Perspective view of a vertical compartment section (3) showing the locations of the drive modules (14) and access to them by removal of maintenance cover (16). Element 15 illustrates the housing, and element (36) the bearing housing of the drive modules.

FIG. 10: Perspective view of standard attachment of the top application (2) to shock-absorbing anchorage points (25) of the autonomous vehicle (1), with anchorage points for bolted connections (6) on the base frame of the top application.

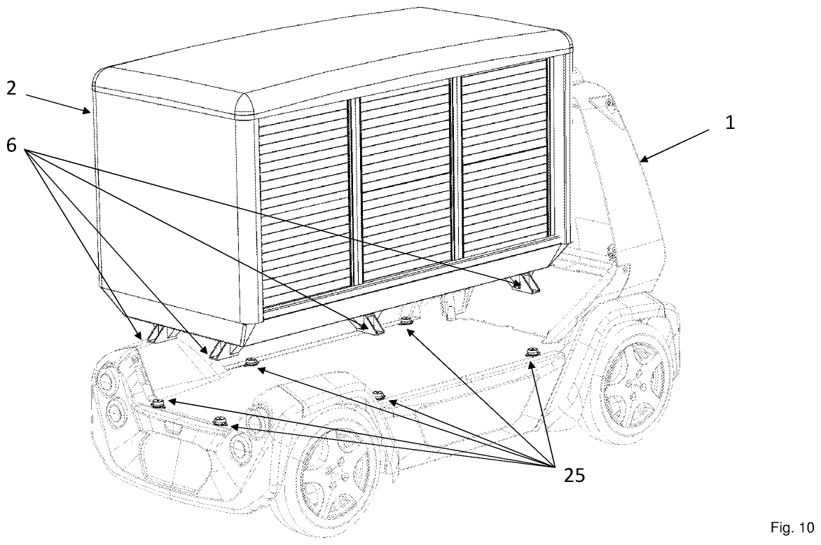

FIG. 11: Perspective view of three anchorage point attachment of top application (2) to the autonomous vehicle (1). Element 20 is a spherical head attachable to the mounting module (22) on the vehicle. Element (21) illustrates a securing clip on the vehicle. Element (23) illustrates anchorage points of the base frame with three anchorages.

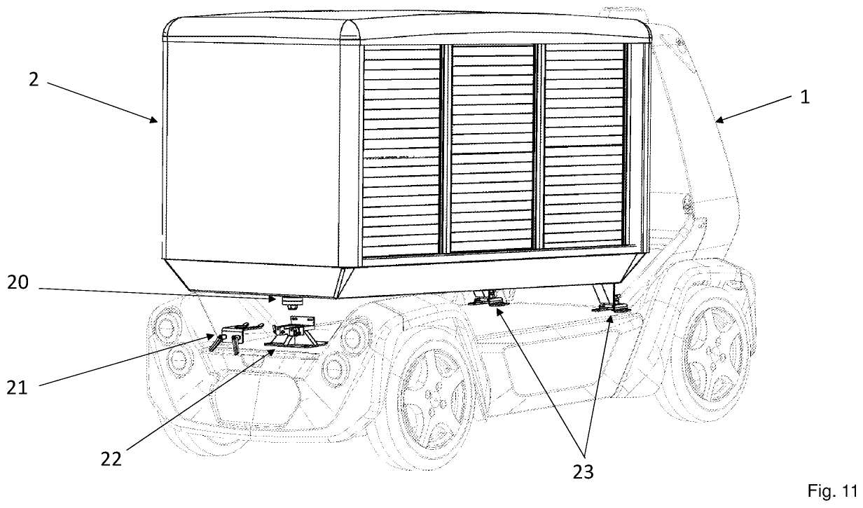

FIG. 12: Perspective view of the top application (2) showing three vertical compartment sections (3), two of which have the door modules (7,8) in open positions thus forming an access opening sized such that a parcel (24) placed in selected compartment can be accessed. The drawing illustrates how the size of the access opening is determined by the computerised system such that only the selected parcels are revealed. Moreover, the figure illustrates how more than one compartment can be revealed at the same time as the opened compartments are located in different vertical compartment sections and as the sliding door modules of each compartment section is independently controlled. The situation illustrated in the figure allows for two parcels (24) of the same customer to be retrieved at same time.

FIG. 13: Perspective view of insertion of parcels (24) in the top application (2). For dynamic use of the vertical compartment section, the parcel (24) is placed in a free compartment and the shelf (13) is placed on a free shelving track (31) right above the parcel (24).

### DETAILED DESCRIPTION OF THE INVENTION

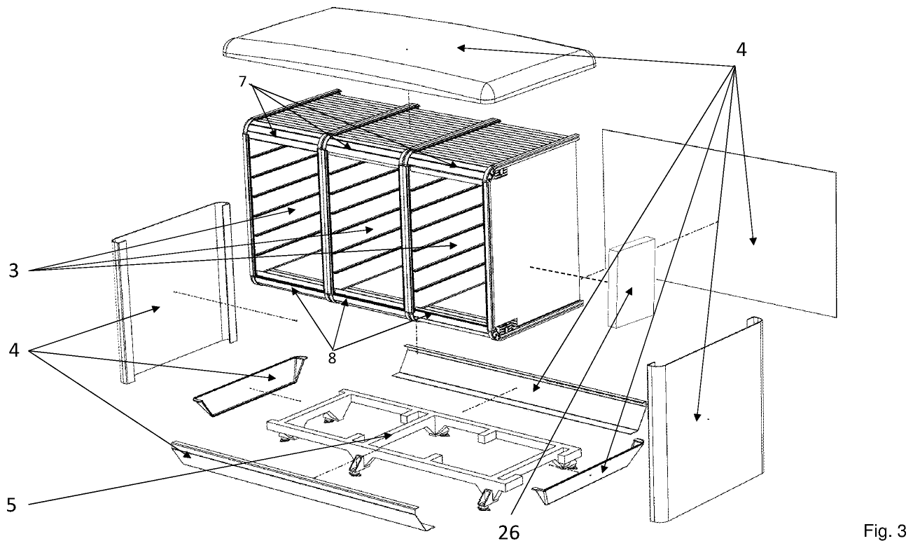

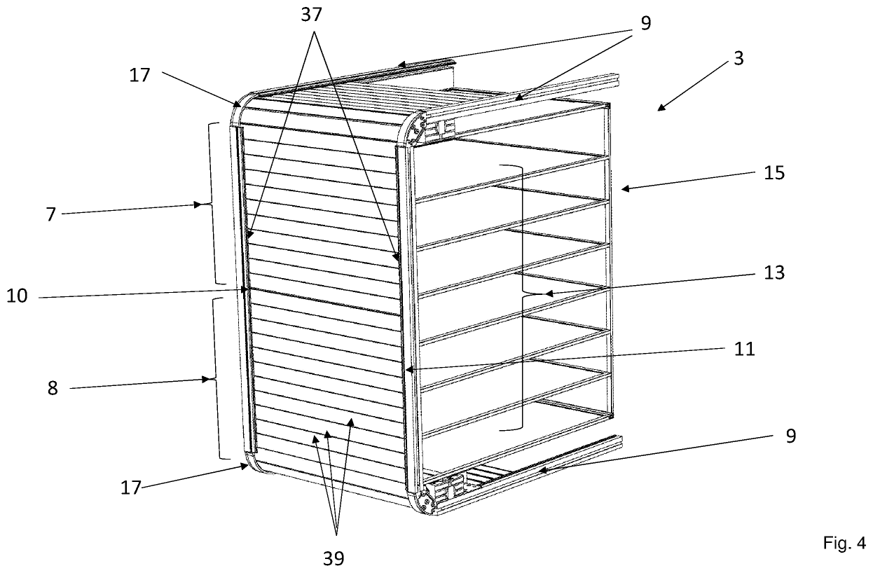

The top application of an autonomous vehicle comprises a base frame (5, shown in FIG. 3) on top of which an arrangement of one or more vertical compartment sections (3) are attached. In a preferred embodiment the top application has three vertical compartment sections, but any other number is possible, depending on the size of the autonomous vehicle, and the type of parcels or items to be delivered. Regardless of the number of vertical compartment sections (3) in the top application (2), the structure of the vertical compartment sections is the same—only the dimensions and configuration of the sections change (FIG. 4, 5, 6).

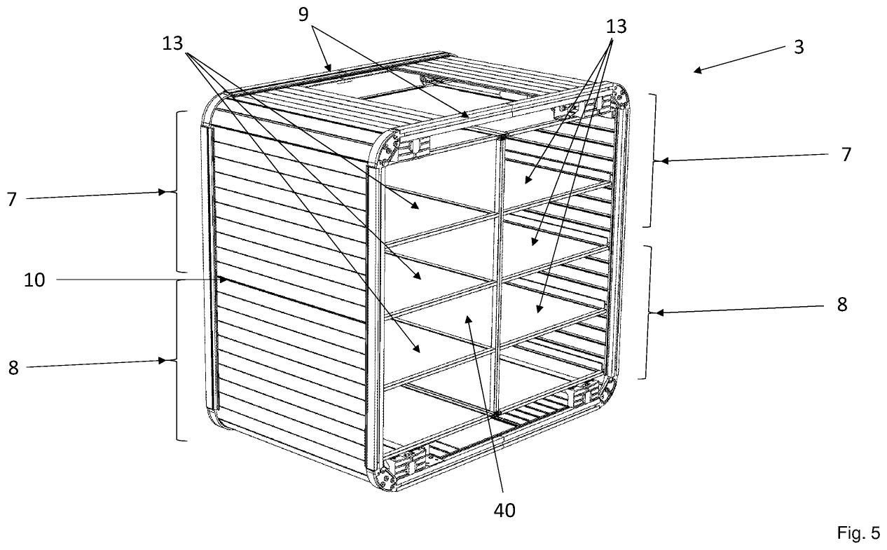

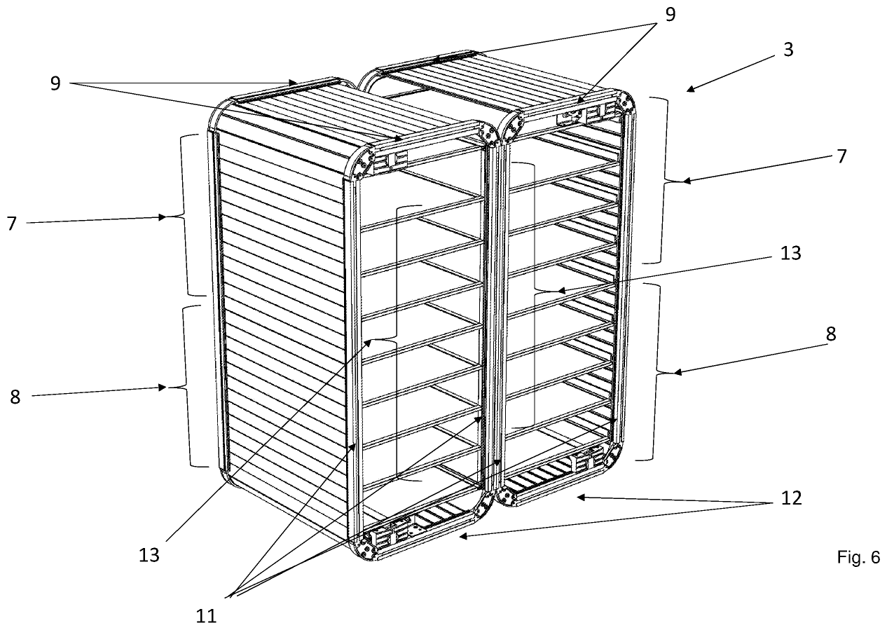

Each vertical compartment section may be single-sided (FIG. 4), i.e., opening only on one side and thus accessible from only one side of the vehicle. The vertical compartment sections may also be two sided (FIG. 5), i.e., opening on both sides and thus accessible from both sides of the vehicle. A two-sided vertical compartment section may have two sets of compartments as shown in FIGS. 5 and 6. The two sets of compartments may be separated by a vertical partition as shown in FIG. 5. Alternatively, the two sets of compartments may have separate circular tracks (comprising two horizontal door guide rails, two vertical door guide rails and four connecting rails), as is shown in FIG. 6. It is possible to have a top application comprising both single-sided and double-sided vertical compartment sections.

It is possible to have one or more of the vertical compartment sections provided with a temperature control. Alternatively, some of the compartment sections may be equipped with thermal isolation material.

Access to the compartments defined by shelves (13) inserted into the vertical compartment section is provided by a unique sliding door assembly. FIG. 4 illustrates a one-sided vertical compartment section. Inside the section a multitude of compartments are formed by the shelves (13). The compartments are accessible by movements of the sliding door assembly which comprises a top door module (7) and a bottom door module (8). The door modules are formed of horizontal strips (39), preferably aluminium strips, attached from both ends in between of two sliding tracks (a sliding track comprises horizontal and vertical door guide rails connected with connecting rails). FIG. 6 illustrates a double-sided vertical compartment section (3) where there are two circular sliding tracks, where each sliding track comprises two vertical guide rails (11) and two horizontal guide rails (9) as well as four connecting guiderails (17).

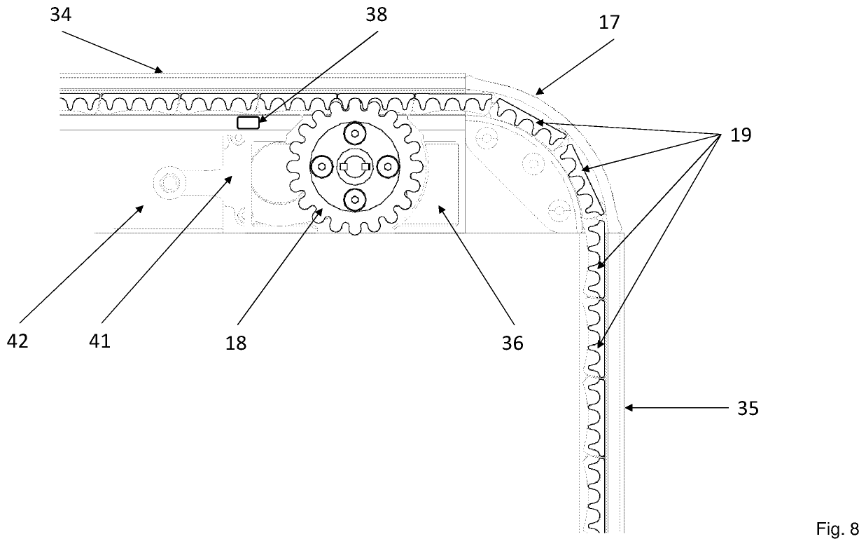

The top door module (7) and the bottom door module (8) are arranged to move along the guide rails such that they are capable of opening access to a compartment when a bottom edge of the top door module and the top edge of the bottom door module are not adjacent to each other. The position of the access opening is controlled by moving the door modules either up or down. Operation of the sliding door assembly is illustrated and explained in more details later below in reference to FIG. 8.

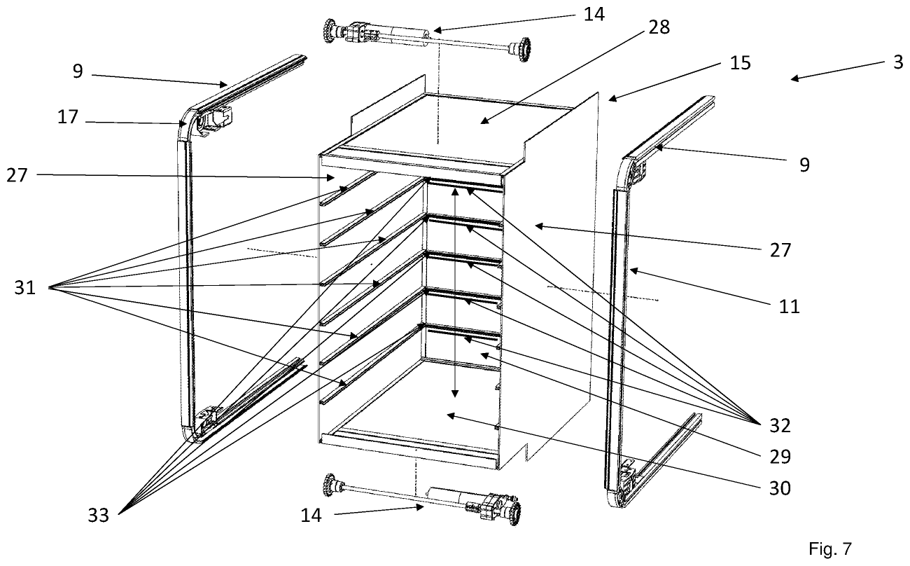

Each vertical compartment section (3) comprises a housing shown as element 15 in FIG. 4. The shelving tracks (31 shown in FIG. 7) are attached inside the side walls (27) of the housing. Shelf height sensors (33 in FIG. 7) are installed at the end of the shelving tracks. Internal lighting elements (32) are installed on a back wall of the housing for each compartment.

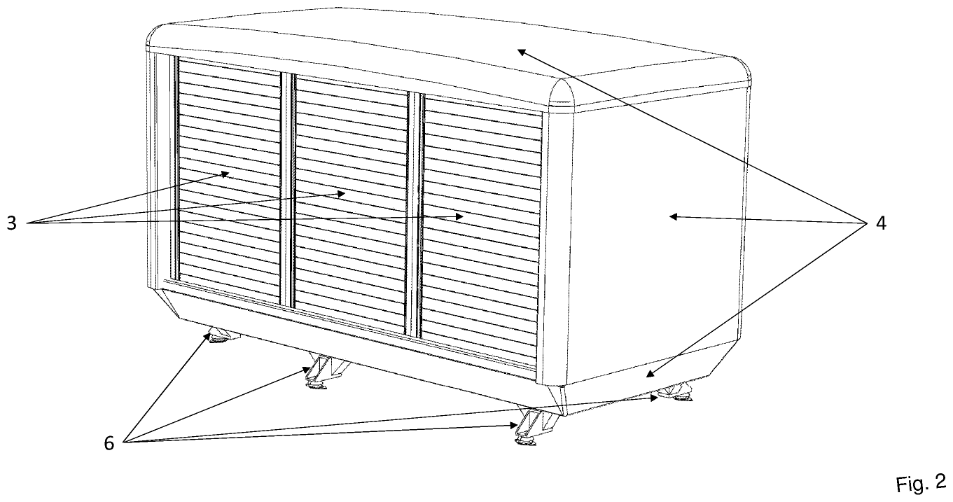

The housing of each vertical compartment section (15) comprises the sides (27), back wall (29), ceiling (28), and floor (30) (shown in FIG. 7). The sides, the back and the ceiling may be covered by cover panels (4) as shown in FIGS. 2 and 3.

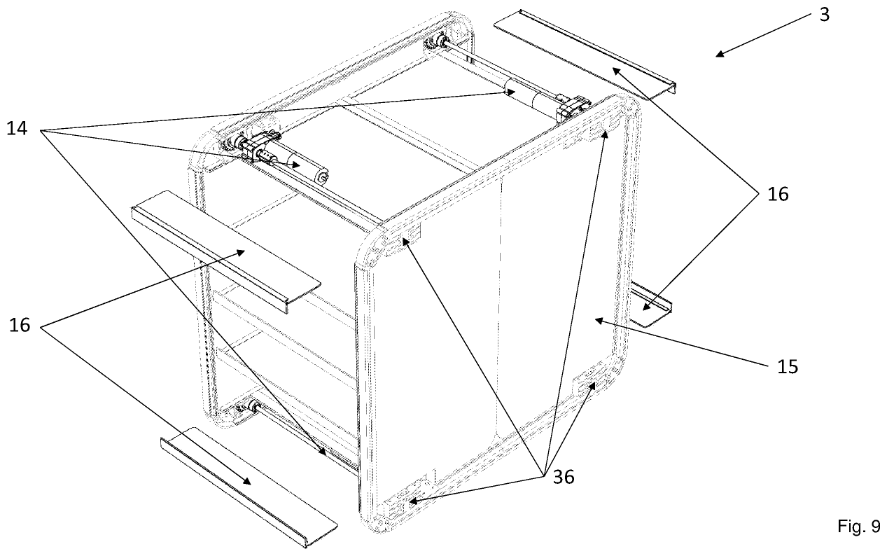

The ceiling and floor comprise also a detachable maintenance cover (16) (shown in FIG. 9). The detachable maintenance cover is necessary for providing access to the drive modules of the doors (14) (FIG. 9). The shelves (13), floor (30) and its detachable maintenance cover (16) may be covered with an anti-slip layer. The shelves (13) comprise a strong front edge and a shelf fastener. The shelf fastener automatically locks (not shown) the shelf in place. To remove the shelf, the automatic lock must be released.

Referring now to FIG. 8, the mechanism of the sliding doors is explained. Horizontal sliding guide (here number 34) as well as vertical sliding guide (here number 35) are shown. A connecting guiding rail (17) is shown to connect the vertical and horizontal guide rails. The connecting guiding rail is preferably made of plastic, but other materials may be used also. The door modules (the top door module and the bottom door module) are made of aluminium strips (39, in FIG. 4)), and each aluminium strip has toothed strip end (19) at their both ends. The toothed strip ends (19) are constructed such that the teeth match with teeth of a driving wheel (18) when the aluminium strips are on the horizontal sliding guide (shown in FIG. 8). The teeth do not touch the driving wheel when the strips are on the vertical sliding guide. The driving wheels (18) are located at both ends of drive modules (14) as shown in FIG. 7.

As illustrated further in FIGS. 7 and 8, the door drive module (14) comprises a gear motor, transmission module between the motor and shaft, drive shafts, stabiliser plate of drive (41), driving wheels (18), bearings, and the fasteners of shafts and driving wheels. Power from the gear motor is transferred to driving wheels through the transmission module. The gear motor and drive shafts are parallel to each other, making the drive module very compact. To ensure that the gear motor stays in place and does not spin around the drive shaft, the transmission module is connected to the stabiliser plate (41) which in turn, through the stabiliser plate, is attached to the shaft track module of the stabiliser plate response (42). There is a rubber pad on the shaft of the stabiliser plate to soften any potential shocks to the drive module. During installation, the bearings of the drive module are pushed into the bearing housings of the track module. Driving wheels (18) are located at a suitable height in respect to the toothed strip ends (19) to allow proper matching with the toothed ends of the horizontal strips (39) of the door assemblies and thus do not require separate adjustment.

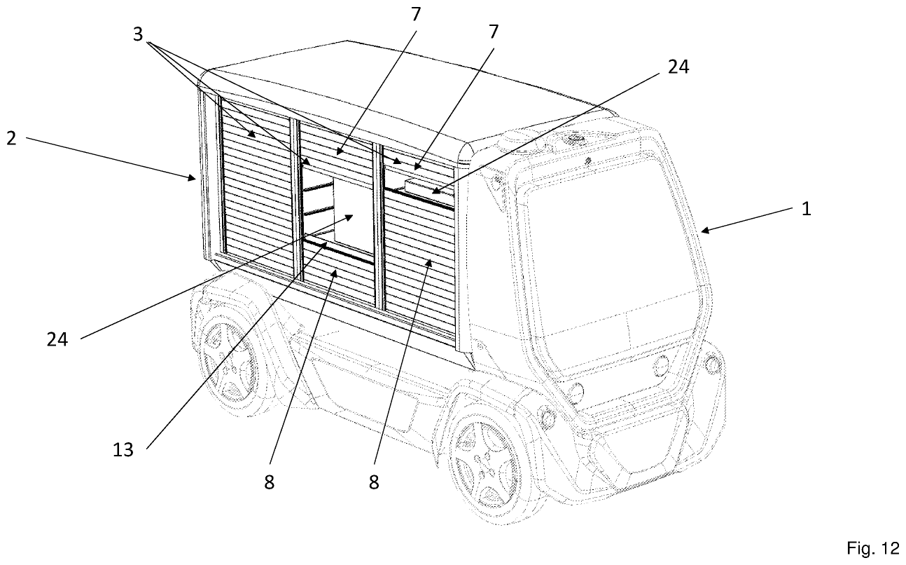

The top application (2) may be connected to a server in order to process data, generate user and parcel codes and for identifying users with the web application or smart device application, as well as sending data to the top application. A code generated for a customer retrieving an ordered parcel from the top application may be a single use code which connects the customer, the parcel and parcel data. In an embodiment, the parcel may be delivered to the user, i.e. a compartment where the parcel is will be opened to access upon entering the code at the top application by a touch pad, a key pad or by scanning the code at the top touch-free. If the generated code contains information about several parcels, the top application may open several compartments at same time as is illustrated in FIG. 12 or one after another without a need to enter the code or the codes again. The code may be generated for the customer in a smart device application or in a web application. The code for the customer may be generated and forwarded automatically by the server as soon as the top application has sent the data concerning the loaded parcel to the server.

The top application may include computing hardware for carrying out the functions, processes, steps, etc. of this disclosure. In an embodiment, the top application may include a first computing device, such as a general-purpose computer having a computer-readable memory with instructions and a processor executing those instructions, that provides a user interface, and effects communications with the server. The top application nay further include a second computing device that controls movement of the door modules of the vertical compartment sections. The second computing device may receive movement commands from the first processing device and transmit movement instructions to the mechanical components. The second computing device may be a programmable logic controller (PLC) in an embodiment. The second computing device may also control opening and closing of the door nodules responsive to input from the first computing device. It should be noted that, although specific computing hardware is noted above for the first and second computing devices, any type of appropriate computing hardware may be used for any computing device in the parcel terminal, including but not limited to a general-purpose computer, a PLC, another programmable logic device (PLD), an application-specific integrated circuit (ASIC), etc. Further, it should be noted that functions, processes, steps, etc. of this disclosure that are carried out by such computing devices may be embodied in any combination of software, digital hardware, and analog hardware. Still further, although two computing devices are explicitly described above, it should be appreciated that the functions, processes, steps, etc. of this disclosure may be carried out by a single computing device, by two computing devices, or by more than two computing devices of the top application.

Insertion of Parcels in a Top Application with Pre-Configured Shelf Heights:

The height of the parcels should correspond to the distance of the shelves installed in the vertical compartment section. When the parcel data (parcel dimensions) is entered into the computerized system, a sliding door assembly of one vertical compartment section is opened to reveal a free compartment. The opening takes place by the bottom door module (8) and top door module (7) moving together up or down to the level of a suitable empty shelf (13). The door modules stop at the level of the shelf. After this, the top door module (7) moves upward as much as necessary to fully open a free compartment, i.e., the edge of the top door module stops at a level such that the parcel fits through the opening onto the shelf. When the free compartment is the bottom-most compartment, the door modules move together until the edge of the door modules (edges are adjacent to each other) is at a level of a shelf just above the free bottom-most compartment. After this, the bottom door module moves downwards and thus reveals the bottom most compartment. After the parcel is placed in the compartment, the compartment access opening is closed with the respective door module. In case several parcels are to be inserted into the top application, the process described above is repeated.

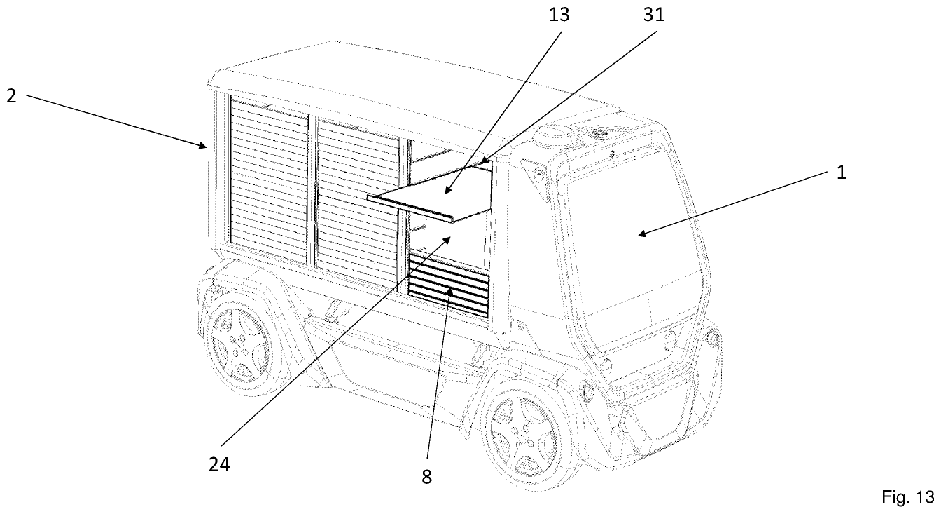

### Modification of Compartment Size (FIG. 13):

In certain embodiments, the distance of the shelves in the vertical compartment sections may be pre-configured. In such case, a parcel may not fit into any existing compartment, but the computerized system opens a compartment that may be smaller than the parcel to be inserted. In this case the size of the compartment has to be changed. In such a case, an input menu for example on a user interface can be used to add space above the compartment by removing the shelf from above ‘the too small compartment’. In order to remove the shelf locking mechanism of the shelf has to be released. Command to release the locking mechanism may be provided by the computerized system and the user can remove the shelf to create bigger compartment where the parcel would fit. The release may also be a mechanical release after which the sensor would sense change of the compartment size and send a signal to the system that the size is changed. The removed shelf can be inserted into another positions in the same vertical compartment section or even into another vertical compartment section. This way the size of the compartments can be modified dynamically depending on the need.

The advantage of the dynamic system provided by the current invention, there is a multitude of variations to use the space in the vertical compartment sections. The size of the compartments in the vertical compartment sections can be quickly and easily changed depending on the need. For example, the shelves of one or more of the vertical compartment sections of the top application may be configured to be suitable for multitude of small items, such a letters or small packages that then may be delivered to recipients/customer. The same top application or part of the vertical compartment sections may after the delivery be modified to be suitable for larger items and the same vehicle and top application can now deliver items of very different size than the previous delivery. Moreover, the top application may be removable and can be replaced by another top application having for example fewer vertical compartments sections suitable for larger items. The top application removed from the vehicle may be battery powered and may thus be used as a temporary parcel terminal for as long as the battery is providing power.

### Retrieving One or Multiple Parcels

Once the autonomous delivery vehicle arrives to the location of the customer a code may be sent to the customer for example via a smart phone application. The code may also be provided at the time the order was made, or any time between the order and the delivery. To retrieve the parcel, the customer has to enter the code for example via a user interface, after which one or several vertical compartment sections are opened in accordance with the number, location and size of the parcels the customer ordered. FIG. 12 illustrates a situation where two parcels are retrieved by one customer. The parcels are in different vertical compartment sections and therefore the doors of two sections have to be opened to reveal the ordered items in the compartments. The doors can open at same time or they can open one after another. Once the customer has removed the parcel from the compartment a sensor may send information via a server to computer that then causes the door modules to close. Alternatively, the customer may enter information via the user interface that the parcel is retrieved.

### LIST OF ELEMENT NUMBERS

1. Autonomous vehicle
2. Top application
3. Vertical compartment section
4. Top application cover panels
5. Base frame
6. Anchorage points of base frame in the case of bolted fixing
7. Top door module
8. Bottom door module
9. Horizontal door guide rails
10. Adjacent edges of top and bottom door modules
11. Vertical door guide rails
12. Two sets of compartments with separate circular tracks
13. Shelves
14. Drive module
15. Housing of a vertical compartment section
16. Detachable maintenance cover
17. Connecting guide rails
18. Drive wheel
19. Toothed strip ends
20. Spherical head
21. Securing clip
22. Mounting module for spherical head
23. Anchorage points of base frame with three anchorages
24. Customer's parcel
25. Shock-absorbing anchorage points
26. Electricity and communications connection
27. Side of housing of vertical compartment section
28. Ceiling of housing of vertical compartment section
29. Back wall of housing of vertical section
30. Floor of housing of vertical section
31. Shelving tracks
32. Internal lighting
33. Shelf height sensor
34. Horizontal door guide rail (same as 9)
35. Vertical door guide rail (same as 11)
36. Bearing housings of drive modules
37. Weatherproof seal
38. Door home sensor
39. Horizontal strips of the doors
40. Partition between compartments
41. Stabiliser plate
42. Stabiliser plate response

1. A top application configured to be mounted on an autonomous delivery vehicle, the top application comprising:
a base frame comprising means for attachment onto the autonomous delivery vehicle;
an arrangement of at least one vertical compartment section on the base frame; and
the at least one vertical compartment section comprising a housing for one or more compartments defined by shelves, and a computer operated sliding door assembly,
wherein the computer operated sliding door assembly comprises a bottom door module and a top door module configured to slidingly move along door guide rails such that the door assembly is closed when a lower edge of the top door assembly and an upper edge of the bottom door assembly are adjacent to each other, and wherein the door assembly is configured to move to a position where the adjacent edges locate at a level of a predetermined shelf, and the top door module is moving upward or the bottom door module is moving downward to create an access opening between the door modules at the level of the predetermined shelf for inserting a parcel to or receiving a parcel from the predetermined shelf.

2. The top application of claim 1, wherein opening of access to a predetermined shelf is triggered by entering an individualized code containing information related to the parcel.

3. The top application of claim 1, wherein the top application has multiple vertical compartment sections, preferably three vertical compartment section.

4. The top application of claim 1, wherein the computer operated sliding door assembly of each vertical compartment section are independent of each other.

5. The top application of claim 1, wherein each vertical compartment section is capable of providing access to a compartment simultaneously, thereby allowing insert or retrieval of several parcels in separate compartments simultaneously.

6. The top application of claim 1, wherein at least one of the at least one vertical compartment sections is single sided, thus having sliding door assembly only on one side.

7. The top application of claim 1, wherein at least one of the at least one vertical compartment sections is double sided, thus having a sliding door assembly on two sides of the vertical compartment section.

8. The top application of claim 1, wherein at least one of the at least one vertical compartments section comprises both single sided and double side section.

9. The top application of claim 1, wherein the top application is configured to be mounted on top of the vehicle permanently.

10. The top application of claim 1, wherein the top application is configured to be mounted on top of the autonomous delivery vehicle in a removable manner.

11. The top application of claim 1, wherein the top application has a battery power.

12. The top application of claim 11, wherein the top application is configured to be mounted on the autonomous delivery vehicle in a removable manner and the computer operated sliding door assembly is configured to be fully functional when the top application is removed from the autonomous delivery vehicle.

13. The top application of claim 1, wherein size of the at least one vertical compartment is changeable based on actual size of items stored in top application by removing and rearranging shelves in one or more vertical compartment sections.

14. An autonomous delivery vehicle comprising a top application according to claim 1.

15. The autonomous delivery vehicle according to claim 14, wherein the top application is mounted on the vehicle permanently or removably.
